(19) United States
(12) Patent Application Publication
(10) Pub. No.: US 2011/0256494 A1
(43) Pub. Date: Oct. 20, 2011

(54) Wax Melting Device

(76) Inventors: Lydia Hannelore Braun, Lauf-Anbach (DE); Rudolf Valenhin Braun, Lauf-Anbach (DE)

(21) Appl. No.: 13/081,397

(22) Filed: Apr. 6, 2011

(30) Foreign Application Priority Data
Apr. 16, 2010 (DE) DE202010005230 U1

(51) Int. Cl. F27B 19/00

(52) U.S. Cl. 432/90

(57) ABSTRACT

Embodiments of the invention relate to a wax melting device and related methods of separating beeswax from a honeycomb structure. Some embodiments accommodate honeycombs of varying sizes. Additionally, some embodiments include independently adjustable supports that allow the device to be tilted so that molten wax can more easily drain. Furthermore, some embodiment include one or more thermally insulated walls and/or an insulated cover.

This application claims priority to German patent application number DE 20 2010 005 230.0 U1 filed Apr. 16, 2010 and now pending which is incorporated herein by reference in its entirety.

### I. BACKGROUND OF THE INVENTION

A. Field of Invention

Embodiments of the present invention generally relate to wax-melting devices and related methods.

B. Description of the Related Art

Devices for separating beeswax from honeycombs are known in the art but include many shortcomings. One such prior device has a melt container for receiving a plurality of honeycomb frames, each of which comprises a honeycomb panel and two bearing projections at opposite ends, and a suspension device with two spaced bearing elements for the honeycomb frames. The melt container can be closed by an upper cover. Steam is fed into the melt container via an inlet. The melt container and the cover consist of thin sheet metal. The bearing elements are formed at the top at the edge of the side walls of the melt container. The honeycomb frames are suspended in the melt container, where the bearing projections bear on the spaced bearing elements. From a steam generator steam is introduced into the melt container. The honeycomb frames were part of a beehive and contain beeswax and pomace, including cocoons of the larvae, pollen residues, and related impurities and unwanted matter. Due to the steam the wax melts and runs through a sieve of the melt container and over a horizontal base wall further to an outlet opening. The pomace is held back by the sieve.

A disadvantage of existing wax-melting devices, such as the foregoing device, lies in the fact that the size of the honeycomb frames must be adapted to the size of the melt container. Thus it is not possible to use arbitrary honeycomb frames. An additional disadvantage lies in the fact that the wax runs off over the horizontal base. Still another disadvantage lies in the fact that the melting device requires a great deal of energy. The container is formed to be relatively deep so that an unnecessarily large volume must be filled with steam and heated. The energy requirement of the melting device is increased significantly more due to the fact that the melt container loses heat through its thin sheet metal walls. Still another disadvantage lies in the fact that there is a relatively great portion of residual wax in the pomace deposited on the sieve. Some embodiments of the present invention may overcome one or more of the foregoing disadvantages.

### II. SUMMARY OF THE INVENTION

Embodiments of the invention include beeswax melting devices and related methods for separating beeswax from honeycombs. A spacing-setting device can be provided in order to determine the spacing of the bearing elements. Using the spacing-setting device it is possible to set different spacings between the two bearing elements. This makes it possible to suspend honeycomb frames of different sizes.

In some embodiments one of the bearing elements is formed as a bearing bar and the spacing-setting device comprises a catch device in which two opposite ends of the bearing bar can engage. In this connection “can engage” includes that the bearing bar can be secured against horizontal displacement.

In some embodiments the bearing bar can engage at different positions so that the wax-melting device can be adapted to frames of different sizes.

In some embodiments the catch device comprises two catch elements with a plurality of catch recesses. The bearing bar can be released by a vertical movement of the catch elements and then can be inserted into other catch recesses. The catch elements as well as the bearing bar can be formed in a particularly simple manner.

In some embodiments side walls of the melt container comprise an insulating layer.

In some embodiments base walls of the melt container comprises an insulating layer.

In some embodiments a cover is provided which comprises an insulating layer.

In some embodiments, due to the insulating layers at the side walls, the base wall and the cover, the energy requirement of the melting device can be sharply reduced and the portion of residual wax which continues to adhere to the pomace can be significantly reduced.

In some embodiments the insulating layer comprises, or the insulating layers comprise, damping foam which is foamed in between two facing metal sheets. Such insulation can be produced in a particularly simple manner and is well protected against external effects.

In some embodiments several supports are provided, each of which comprises a length-adjusting device so that the wax-melting device can be disposed so as to have an inclination. In this connection “so as to have an inclination” includes that a base wall of the melt container is aligned so as to have an inclination with respect to the horizontal.

In some embodiments the wax then flows better through an outlet. In addition, secure seating of the wax-melting device can be provided using the length-adjusting device.

In some embodiments the bearing elements can be aligned so as to be offset in the vertical direction so that the honeycomb frames can be suspended so as to have an inclination. “can be aligned so as to be offset in the vertical direction” includes that the bearing elements are disposed basically at different heights, or can be disposed at different heights, if the melting device is set up on plane ground. Aligning the bearing elements so as to be offset in the vertical direction can be effected by an adjustment of the supports. In connection with this the inclination of the honeycomb frames is suitably more than one degree and less than 15 degrees with respect to the horizontal. The inclination of the honeycomb frames causes a better separation of the pomace from the wax so that the pomace only contains a small portion of residual wax.

Embodiments of the invention are described in more detail in the following specification with the aid of drawings. Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective representation of a wax-melting device;

FIG. 2 is a front view of the wax-melting device;

FIG. 3A is a top view of the wax-melting device;

FIG. 3B is a top view of the wax-melting device without the cover;

FIG. 4A is a side view of the wax-melting device; and FIG. 4B a side view of the wax-melting device without a side wall.

### IV. DETAILED DESCRIPTION OF THE INVENTION

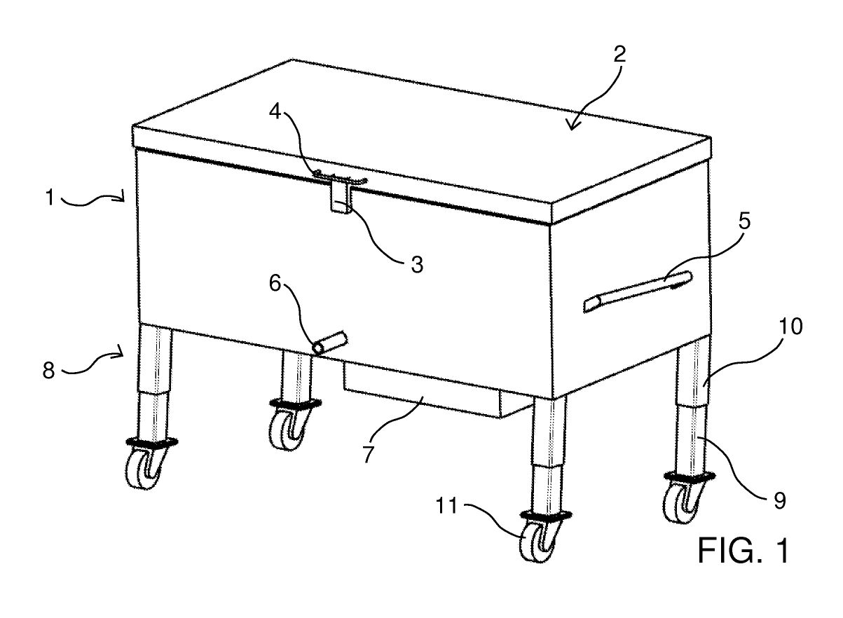

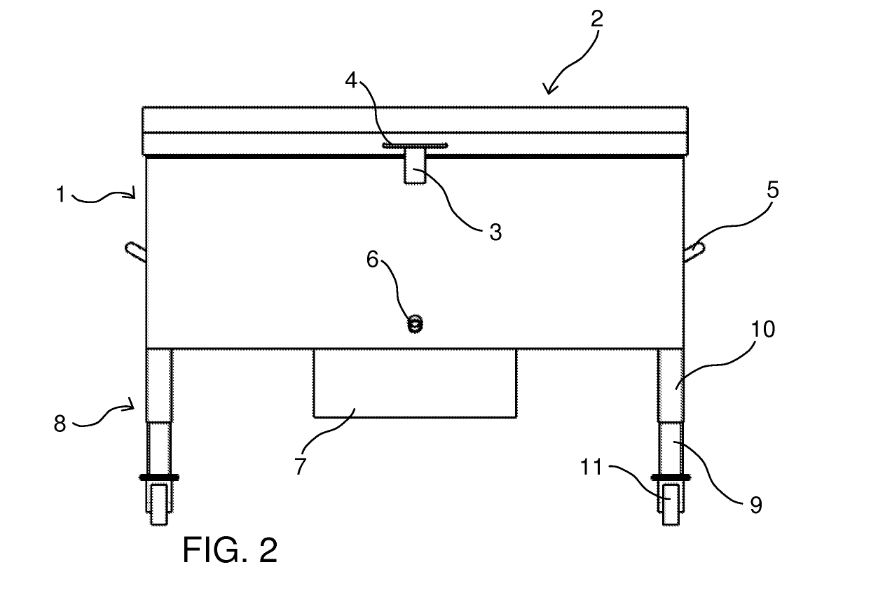

FIG. 1 and FIG. 2 show a perspective representation or a front view of a wax-melting device. The wax-melting device comprises a square melt container 1 with an upper opening. The upper opening is closed by a cover 2. The cover 2 is connected on one side to the back of the longitudinal side of the melt container 1 via a hinge (hidden). On the opposite side of the cover 2 a lock 3, preferably a snap lock, is provided in order to lock the cover 2 in place on a front longitudinal side of the melt container 1. Above the lock 3 a grip 4 is provided on the cover 2. On each of two facing transverse walls of the melt container 1 an additional grip 5 is provided. On the front longitudinal side of the melt container 1 an outlet 6 is provided which empties into a melt chamber of the melt container 1. Under the base of the melt container 1 a steam generator 7 is mounted which generates steam. The steam is introduced into the melt chamber via a line. The steam generator 7 is a commercially available steam generator which can also be provided separately from the melt container 1. The side walls of the melt container 1, the base wall of the melt container 1 and the cover 2 are each formed to have two walls of stainless sheet metal. The space between two metal sheets with a spacing of a few centimeters (at most 10 cm) is sprayed with heat-resistant, heat-insulating foam. The melt container 1 stands on four supports 8. The supports 8 are provided at the four corners of the base wall of the melt container 1, are formed in the manner of a telescope and each comprise a lower support element 9 and an upper support element 10. The lower support elements 9 can each be pushed into the upper support element 10 and locked in place by a locking apparatus. Castors 11 are provided on the supports 8 at the bottom.

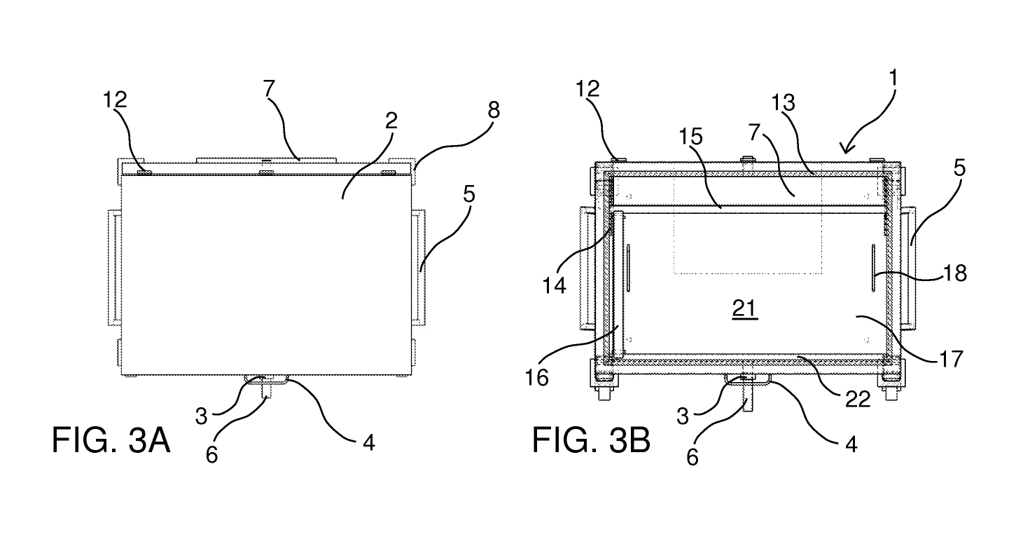

FIG. 3A and FIG. 3B show a top view of the wax-melting device or a top view of the wax-melting device without a cover. Hinges 12 can be seen which in FIG. 1 and FIG. 2 are hidden and with which the cover 2 is fastened to the melt container 1. At the top on the side walls of the melt container 1 a heat-resistant seal 13 is provided which completely encircles an upper opening of the melt chamber 21 and prevents steam from escaping through a gap between the melt container 1 and the cover 12. At the base of the melt chamber 21 a sieve device 17 is disposed in such a manner that it is loose. On two opposite sides of the sieve device 17 two grips 18 are formed so that the sieve device 17 can be lifted out easily. At the upper edge of the melt container 1 near to the upper opening, two parallel bearing elements 15 and 22 are disposed. The bearing element 22 is fastened to the front longitudinal wall in such a manner as to be fixed and is aligned horizontally in the longitudinal direction. Two catch elements 14 with several catch recesses still open in the upwards direction are provided on the two opposite transverse walls turned away from the front longitudinal wall. The catch recesses are disposed horizontally with a spacing of at most a few centimeters (at most 10 cm).

The bearing element 15 can be formed as a rectangular tubular bearing bar 15 made of stainless steel and runs horizontally and parallel to the bearing element 22. The opposite ends of the bearing bar 15 each engage in one of the catch recesses of one of the catch elements 14 and are held in the catch recesses. The spacing between the bearing elements 15, 22 can be adapted to honeycomb frames 16 due to the fact that the bearing element 15 (the bearing bar) can engage in different catch recesses. The bearing projections at opposite ends of the honeycomb frame 16 bear on the bearing elements 15, 22. Additional honeycomb frames 16 are not represented in order to conceal as little of the melting device as possible. The position of the steam generator 7 which is hidden by the base wall of the melt container 1 is represented with a dotted line.

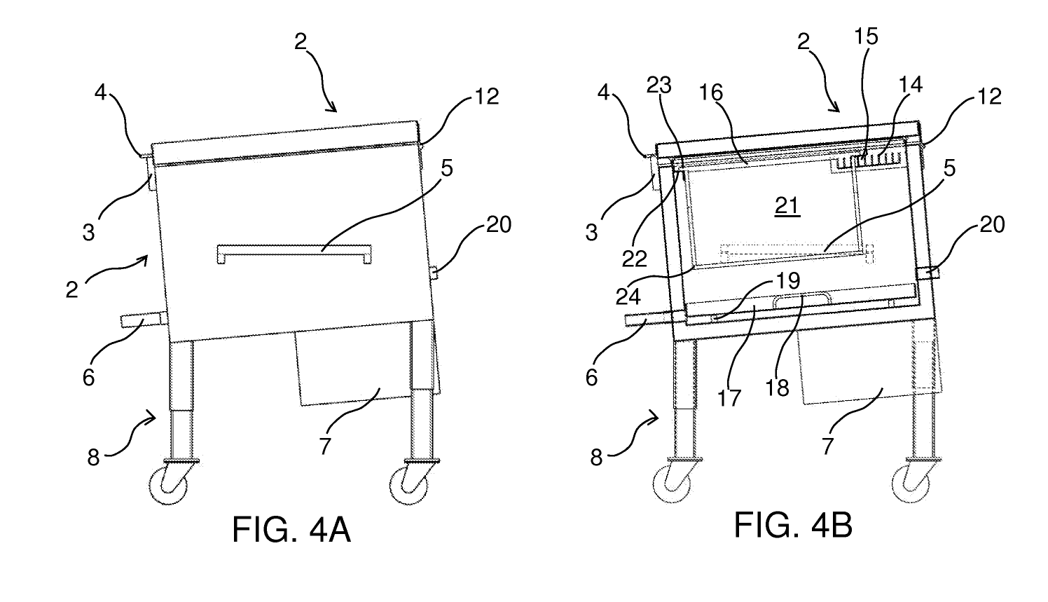

FIG. 4A and FIG. 4B show a side view of the wax-melting device or a side view of the wax-melting device without a side wall. The lengths of the supports 8 are adjusted so that the melt container 1 is inclined towards the front and a surface of the base wall of the melt container is inclined at an angle between 1 degree and 15 degrees with respect to the horizontal. On the rear side of the melt container 1 an inlet for steam is provided. A supply line (not represented) from the steam generator 7 is connected to the inlet 20. On its lower side the sieve device 17 comprises projections 19 which bear on the base of the melt container 1. Between the lower edge of an opening of the outlet 6 and the base no space is provided, or only a vertical space of a few millimeters is provided. The catch elements 14 are disposed in such a manner that an upper bearing surface of the bearing bar 15, whose ends are engaged in catch recesses of the catch element 14, and an upper bearing surface of the bearing element 22 lie in a plane which preferably runs parallel to the inclined base of the melt container 1. In connection with this the bearing elements 15 and 22 are disposed with a vertical offset. The bearing projections 23 of the honeycomb frames 16 bear on the bearing elements 15 and 22 and are inclined at an angle between 1 degree and 15 degrees with respect to the horizontal. The spacing of a large honeycomb frame 16 from the sieve device 17 is only a few centimeters. The position of one of the grips 5 is represented by a dotted line.

If steam from the steam generator 7 is introduced into the melt chamber 21 via the inlet 20, the wax from the honeycomb panels in the honeycomb frames 16 melts. Due to the inclination of the honeycomb frames 16 the wax first runs along a lower frame strip to a lower corner 24 of the honeycomb frame 16 and from there drops onto the sieve device 17. In connection with this the inclination of the honeycomb frames 16 is preferably more than one degree and less than 15 degrees with respect to the horizontal. The pomace is not capable of flow and falls directly onto the sieve device 17. Only a small portion of the pomace which is deposited on the sieve device 17 comes in contact with wax which drops down from the honeycomb frames 16 and can hold it back. Due to the inclination of the base wall of the melt container 1 the wax flows particularly quickly to the outlet 6 and through it further into a collecting container (not represented)

The embodiments have been described, hereinabove. It will be apparent to those skilled in the art that the above methods and apparatuses may incorporate changes and modifications without departing from the general scope of this invention. It is intended to include all such modifications and alterations insofar as they come within the scope of the appended claims or the equivalents thereof.

Having thus described the invention, it is now claimed:

I/We claim:

1. A wax melting device comprising,
a melt container (1) for receiving a plurality of honeycomb frames (16);
each honeycomb frame comprising a honeycomb panel and two bearing projections (23) at opposite ends of the honeycomb frame;
a suspension device comprising two generally parallel and spaced-apart bearing elements (15, 22) attachable to the melt container, the bearing elements being adapted to receive the honeycomb panel bearing projections in a supportive relation; and
a spacing-setting device (14) defining a plurality of selectable spacings of the bearing elements (15, 22).

2. The wax melting device according to claim 1, wherein one of the bearing elements (15, 22) comprises a bearing bar (15), and wherein the spacing-setting device (14) comprises a pair of catch devices in which two opposing ends of the bearing bar (15) can engage.

3. The wax melting device according to claim 2, wherein the catch device comprises two catch elements (14) with a plurality of catch recesses.

4. The wax melting device according claim 1, wherein the side walls of the melt container (1) comprise an insulating layer, wherein the insulating layer comprises a damping foam disposed between a pair of facing metal sheets.

5. The wax melting device according to claim 1, wherein a base wall of the melt container (1) comprises an insulating layer, wherein the insulating layer comprises a damping foam disposed between a pair of facing metal sheets.

6. The wax melting device according to claim 1, further comprising a cover (2) which comprises an insulating layer, wherein the insulating layer comprises a damping foam disposed between a pair of facing metal sheets.

7. The wax melting device according to claim 1, further comprising several supports (8) are provided, each of which comprises a length-adjusting device.

8. The wax melting device according to claim 7, wherein the bearing elements (15, 22) can be aligned with a vertical offset so that the honeycomb frames (16) can be suspended with an inclination.

9. A wax melting device comprising,
a melt container for receiving a plurality of honeycomb frames, the melt container including a cover for closing the melt container;
each honeycomb frame comprising a honeycomb panel and two bearing projections at opposite ends of the honeycomb frame;
a suspension device comprising two generally parallel and spaced-apart bearing elements attachable to the melt container, the bearing elements being adapted to receive the honeycomb panel bearing projections in a supportive relation;
a spacing-setting device adapted to receive one of the two bearing elements and defining a plurality of selectable spacings of the bearing elements;
a sieve disposed at a base of the melt container and adapted to receive molten wax drippings from the honeycomb panels and to retain pomace while allowing molten wax to pass through the sieve;
an outlet in fluid communication with the melt container and disposed under an upper surface of the sieve, the outlet being adapted to empty molten wax from the melt container; and
a steam generator in fluid communication with the melt container and adapted to deliver steam to the melt container.

10. The wax melting device of claim 9, further comprising four telescoping vertical supports disposed near the corners of the melt container.

11. The wax melting device of claim 10, wherein each vertical support is independently adjustable such that the melt container can be tilted at least in a forward orientation and cause the flow of molten wax to be biased toward the outlet.

12. The wax melting device of claim 10, wherein the melt container comprises at least a pair of metal sheets spaced apart and including insulating foam therebetween.

13. A wax melting device, comprising:
a melt container defined by four side walls and a base wall, the four side walls defining a rectangular shape and comprising a front wall and a back wall generally parallel to each other, and a pair of transverse side walls generally parallel to each other, the combination of the four side walls and the base wall together defining a melt chamber;
a cover hingedly joined to the back wall of the melt container and defining a closure for the melt chamber;
an outlet in fluid communication with the melt chamber and emptying to an exterior of the melting device, the outlet being disposed in a wall of the melt container;
a sieve member disposed in the melt chamber and on the base wall such that a top surface of the sieve is above a top edge of the outlet;
four telescoping supports disposed near four corners of the base wall of the melt container;
a steam generator in fluid communication with the melt chamber and adapted to deliver steam to the melt chamber;
a first bearing element dispose near the front or back wall of the melt chamber;
a second bearing element generally parallel to the first bearing element and being disposed near an opposing wall of the melt chamber; and
a pair of catch elements attached to opposing transverse walls of the melt chamber and adapted to receive the first or second bearing element in a supportive relation and fixing the distance between the first and second bearing elements, wherein each of the pair of catch elements include a plurality of catch recesses for receiving the first or second bearing element, each catch recess defining a unique distance between the first and second bearing elements.

14. The wax melting device of claim 13, wherein the melt container and cover each comprise a pair of metal sheets spaced apart and including insulating foam therebetween.

15. The wax melting device of claim 13, wherein the four telescoping supports are each independently adjustable such that the melt container can be tilted at least in a forward orientation and cause the flow of molten wax to be biased toward the outlet.
